(19) United States
(12) Patent Application Publication
(10) Pub. No.: US 2015/0083083 A1
(43) Pub. Date: Mar. 26, 2015

(54) ENGINE

(71) Applicant: Yanmar Co., Ltd., Osaka-shi, Osaka (JP)

(72) Inventors: Kazuki Maetani, Osaka-shi (JP); Mitsuhiro Hibino, Osaka-shi (JP)

(21) Appl. No.: 14/388,779

(22) PCT Filed: Jan. 24, 2013
(86) PCT No.: PCT/JP2013/000343

§ 371 Date: Sep. 26, 2014

(30) Foreign Application Priority Data
Mar. 28, 2012 (JP) 2012-073793
Mar. 28, 2012 (JP) 2012-073795

(51) Int. Cl. F02F 1/24; F01N 13/10

(52) U.S. Cl. CPC F02F 1/242; F01N 13/10
USPC 123/470

(57) ABSTRACT

A marine engine includes an exhaust manifold, a valve cover, a top cover, and a fuel supply pipe. The exhaust manifold collects exhaust gases discharged from a plurality of cylinders. The valve cover is a cover that covers all of a plurality of valves for air intake or air discharge to or from the cylinders. The top cover is a cover that covers the valve cover. The fuel supply pipe is arranged in a space between the valve cover and the top cover, and allows a fuel to flow therethrough. The top cover is provided with a partition that is arranged so as to separate the side where the exhaust gas flows immediately after being discharged from the exhaust manifold from the side where the fuel supply pipe is arranged.

### BACKGROUND

1. Technical Field

The present invention relates to an engine in which a fuel tube is arranged on a cylinder head.

2. Background Art

Conventionally known configurations of an engine mounted in an automobile, a ship, or the like, include a configuration provided with a valve cover (cylinder head cover) that covers an air intake valve or an exhaust valve. In an engine of this type, a fuel tube for fuel supply may be arranged on the valve cover. Patent Document 1 discloses this type of engine.

The engine disclosed in the Patent Document 1 is a diesel engine including a common-rail fuel injection mechanism. The common-rail fuel injection mechanism includes, as its main elements, a common rail, a high-pressure tube (fuel tube), and an injector. The common rail, which is arranged above the valve cover, stores under high pressure a fuel supplied from a fuel tank. The high-pressure tube, which is arranged above the valve cover, connects the common rail and the injector to each other. The injector, which is arranged corresponding to each cylinder, injects the fuel in response to an instruction given from an electronic control device.

In an engine mounted in a ship, a cover (top cover) may be arranged in an upper end region of the engine, because an operator works on the upper end of the engine when performing a maintenance operation. Patent Document 2 discloses an engine provided with such a top cover. In the Patent Document 2, a common rail is arranged below the top cover.

### PRIOR-ART DOCUMENTS

### Patent Documents

Patent Document 1: Japanese Patent Application Laid-Open No. 2005-30346

Patent Document 2: Japanese Patent Application Laid-Open No. 2010-59807

### SUMMARY OF THE INVENTION

### Problems to be Solved by the Invention

In the fuel injection mechanism of the diesel engine, sealing is provided in, for example, a connection portion between the common rail and the high-pressure tube, in order to prevent leakage of the fuel. Depending on the use environment or the like, however, loosening of the connection portion, damage to the fuel tube, etc., or the like, may occur, which in the worst case could cause leakage of the fuel. Occurrence of leakage of the fuel may cause the fuel to burst and splash because the fuel is stored under high pressure in the high-pressure tube.

Conventionally, therefore, a high-temperature part (for example, a part through which an exhaust gas passes) of the engine that might be exposed to the fuel, even a small chance, needs to be covered with a heat insulating material or the like. In some cases, in addition to or instead of the covering with the heat insulating material, the high-pressure tube may be double-structured for ensuring the prevention of leakage of the fuel.

Such a configuration adopting the covering with the heat insulating material or the like leads to an increased number of parts and a complicated assembling process. Particularly in an engine including a plurality of cylinders, the length of a high-pressure tube is elongated, so that the range in which where is the risk of fuel splashing is widened. Additionally, the high-pressure tube (fuel tube) is arranged for each cylinder. In an engine including a plurality of cylinders, therefore, many high-pressure tubes need to be double-structured. This increases the number of cylinders included in the engine, which leads to an increase in the cost, labor in the production, and complication of the assembling process.

The present invention has been made in view of the circumstances described above, and a primary object of the present invention is to provide an engine configured such that a high-temperature part is not exposed to a fuel when, for example, a high-pressure tube is damaged, at a low cost and with a simple structure.

### Means for Solving the Problems and Effects Thereof

Problems to be solved by the present invention are as described above, and next, means for solving the problems and effects thereof will be described.

In an aspect of the present invention, an engine having the following configuration is provided. The engine includes an exhaust manifold, a valve cover, a plate-like cover, and a fuel tube. The exhaust manifold collects exhaust gases discharged from a plurality of cylinders. The valve cover is a cover that covers all of a plurality of valves for air intake or air discharge to or from the cylinders. The plate-like cover is a cover that covers the valve cover. The fuel tube is arranged in a space between the valve cover and the plate-like cover, and allows a fuel to flow therethrough. The plate-like cover is provided with a partition that is arranged so as to separate a side where the exhaust gas flows immediately after being discharged from the exhaust manifold from a side where the fuel tube is arranged.

Accordingly, even when the fuel leaks out of the fuel tube, a part (a high-temperature part of the engine) through which the exhaust gas passes can be prevented from being exposed to the fuel. This can eliminate the need of double-structuring the fuel tube for the purpose of preventing leakage of the fuel, and moreover can eliminate the need of covering an exhaust pipe and the like with a heat insulating material for the purpose of lowering the surface temperature. Additionally, since the partition is included in the plate-like cover, it is not necessary to provide any special member for supporting the partition. Thus, the above-described problems can be solved at a low cost and with a simple structure.

In the engine, it is preferable that the partition has a height that occupies half or more of the distance between the valve cover and the plate-like cover.

This makes it easy for the partition to catch the fuel splashing from the fuel tube, thus more surely preventing the high-temperature part of the engine from being exposed to the fuel.

In the engine, it is preferable that the partition is formed so as to extend from one end to the other end of the plate-like cover with respect to a crank axis direction.

Accordingly, the high-temperature part of the engine can be prevented from being exposed to the fuel even in a case where the fuel tube is arranged in an elongated manner in the crank axis direction.

In the engine, it is preferable that the partition is a plate-like portion that is formed integrally with the plate-like cover and that protrudes perpendicularly from the plate-like cover.

Since the partition and the plate-like cover are formed integrally with each other, reduction in the number of parts and simplification of an assembling operation are achieved. Additionally, since the partition has a plate-like shape, the space occupied by the partition can be restricted with achievement of the effects of the present invention.

In the engine, it is preferable that the valve cover is provided with a second partition that is arranged so as to separate the side where the exhaust gas flows immediately after being discharged from the exhaust manifold from the side where the fuel tube is arranged.

Accordingly, even when the fuel leaks out of the fuel tube, a part (high-temperature part of the engine) through which the exhaust gas passes can be more surely prevented from being exposed to the fuel.

In the engine, it is preferable that the second partition has a height that occupies half or more of the distance between the valve cover and the plate-like cover.

This makes it easy to catch the fuel splashing from the fuel tube, thus more surely preventing the high-temperature part of the engine from being exposed to the fuel.

In the engine, it is preferable that the second partition is formed so as to extend from one end to the other end of the valve cover with respect to a crank axis direction.

Accordingly, the high-temperature part of the engine can be prevented from being exposed to the fuel even in a case where the fuel tube is arranged in an elongated manner in the crank axis direction.

In the engine, it is preferable that the second partition is a plate-like portion that is formed integrally with the valve cover and that protrudes from the valve cover.

Since the second partition and the valve cover are formed integrally with each other, reduction in the number of parts and simplification of an assembling operation are achieved. Additionally, since the second partition has a plate-like shape, the space occupied by this partition can be restricted with achievement of the effects of the present invention.

In the engine, it is preferable that the partition is arranged near the second partition and on the fuel tube side relative to the second partition.

This enables the fuel, even splashing along the plate-like cover, to be caught without fail.

### BRIEF DESCRIPTION OF THE DRAWINGS

FIG. 1 A perspective view of a marine engine according to an embodiment of the present invention.

FIG. 2 A plan view of the marine engine.

FIG. 3 A front elevational view of the marine engine.

FIG. 4 A perspective view showing members arranged around a valve cover.

FIG. 5 A cross-sectional view showing a space between the valve cover and a top cover.

FIG. 6 Perspective views showing the shapes of the valve cover and the top cover.

FIG. 7 A perspective view showing the positional relationship among devices of an air supply system.

FIG. 8 Cross-sectional views showing another configuration of the valve cover and another configuration of the top cover.

### EMBODIMENT FOR CARRYING OUT THE INVENTION

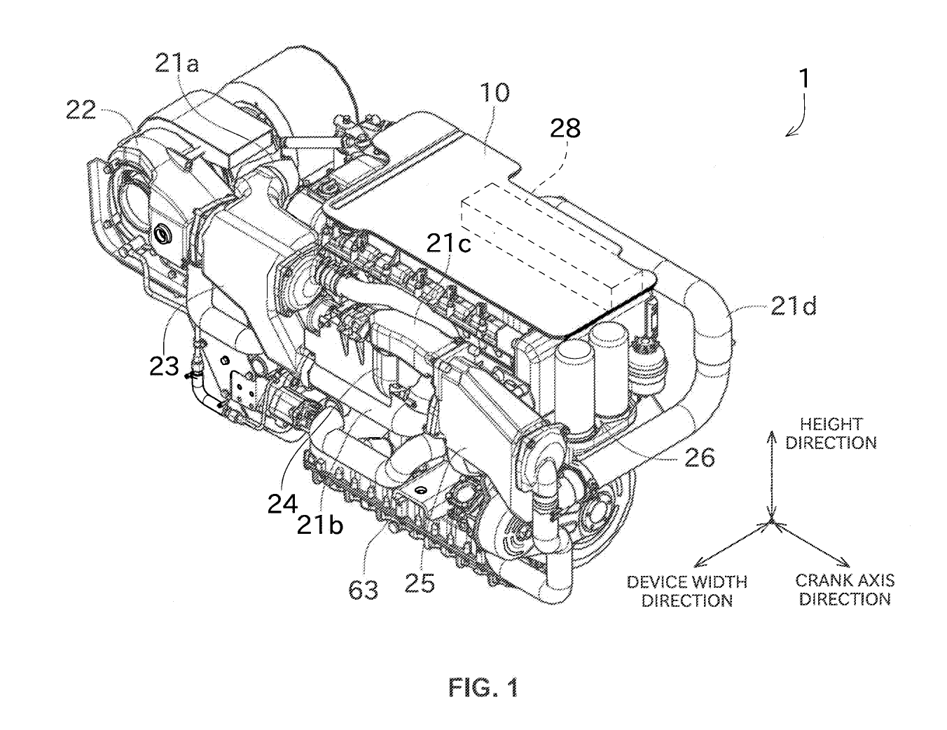

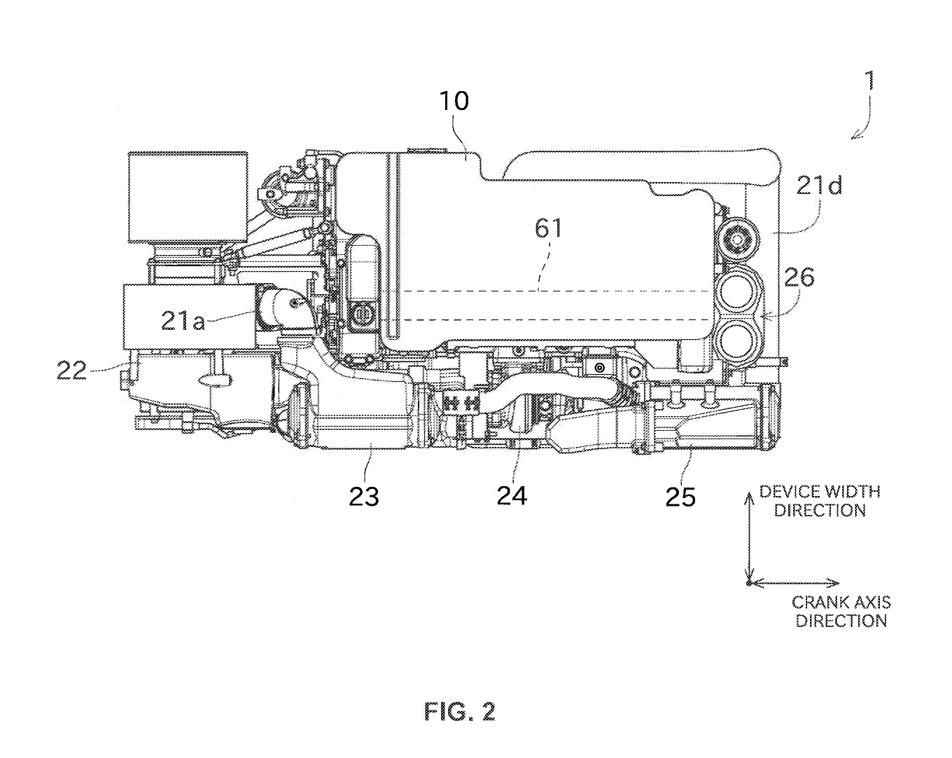

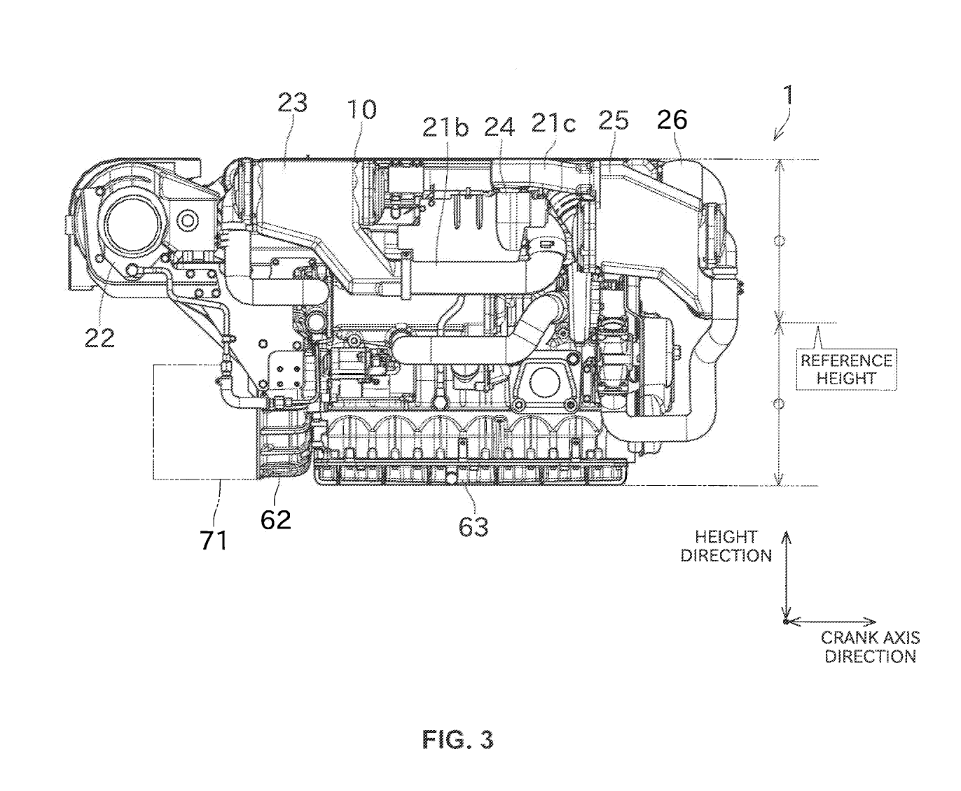

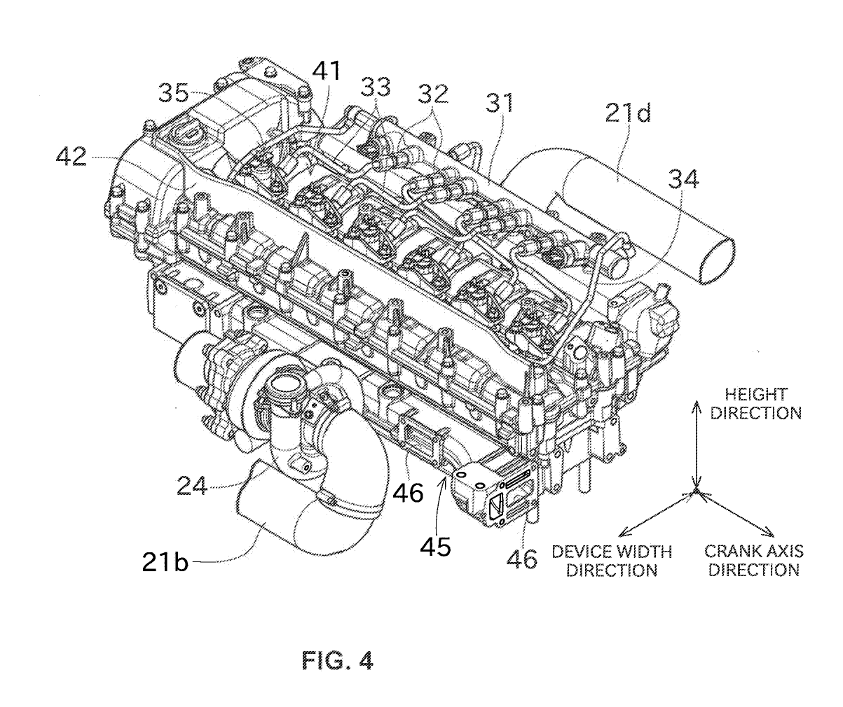

Next, an embodiment of the present invention will be described with reference to the drawings. Firstly, an overall configuration of a marine engine 1 will be described with reference to FIGS. 1 to 4. FIG. 1 is a perspective view of the marine engine 1 according to an embodiment of the present invention. FIG. 2 is a plan view of the marine engine 1. FIG. 3 is a front elevational view of the marine engine 1. FIG. 4 is a perspective view showing members arranged around a valve cover 41.

In the following description, the vertical direction of the marine engine (engine) 1 will be referred to as height direction, the longitudinal direction of a crankshaft 61 (see FIG. 2) of the marine engine 1 will be referred to as crank axis direction, and the direction perpendicular to both the height direction and the crank axis direction will be referred to as device width direction, as shown in FIG. 1. The top side of FIG. 1 (the side in which a top cover 10 which will be described later is arranged) with respect to the height direction is defined as the upper side.

The marine engine 1 of this embodiment is a diesel engine of in-board type that is mounted in a ship such as a pleasure boat. The marine engine 1 adopts a two-stage turbocharging system.

As shown in FIG. 1, etc., the marine engine 1 includes a top cover (plate-like cover) 10. The top cover 10 is in the shape of a flat plate, and arranged with its thickness direction parallel to the height direction. The shape of the top cover 10 is not limited to a flat plate shape, but the top cover 10 may be at least partially bent (or curved). A valve cover, a cylinder block, and the like, are arranged below the top cover 10.

The marine engine 1 includes a two-stage turbocharging system implemented by a first turbocharger 22, a first intercooler 23, a second turbocharger 24, a second intercooler 25, and air supply pipes 21a to 21d that connect them.

The first turbocharger 22 includes a turbine and a compressor provided in a housing. The turbine is configured to rotate by using an exhaust gas. The compressor is connected to a shaft to which the turbine is also connected, and configured to rotate along with rotation of the turbine, Rotation of the compressor enables the first turbocharger 22 to compress air and forcibly supply air. This configuration is able to, by using the exhaust gas, increase the flow volume of air supplied to a cylinder, and thus achieves an increased output of the marine engine 1. Air intake performed by the first turbocharger 22 causes rapid compression of air, which makes the temperature of the air high. This high-temperature air is sent out through the air supply pipe 21a to the first intercooler 23.

A plurality of cooling pipes through which sea water flows are arranged within a housing of the first intercooler 23. The air sent out from the first turbocharger 22 flows around the cooling pipes. Such a configuration enables the first intercooler 23 to cool the air sent out from the first turbocharger 22 by means of heat exchange between the air and the sea water. The air cooled by the first intercooler 23 is sent out through the air supply pipe 21b to the second turbocharger 24.

The second turbocharger 24, which has a configuration equivalent to the configuration of the first turbocharger 22, is able to compress air sent out from the first intercooler 23 by using an exhaust gas. This compressed air has a high temperature in the same manner as described above. The high-temperature air is sent out through the air supply pipe 21 c to the second intercooler 25.

The second intercooler 25, which has a configuration equivalent to the configuration of the first intercooler 23, cools the air sent out from the second turbocharger 24 by means of heat exchange between the air and the sea water. The air cooled by the second intercooler 25 is sent out through the air supply pipe 21d to an air supply manifold 28.

A common-rail fuel injection mechanism is arranged in a cylinder head provided inside the top cover 10. The marine engine 1 is configured such that a compressed air supplied to a cylinder is further compressed and then the fuel injection mechanism injects a fuel to thereby drive a piston up and down. This enables the marine engine 1 to generate power. Details of the fuel injection mechanism will be described later.

A flywheel housing 62 is arranged in an end portion on the first turbocharger 22 side with respect to the crank axis direction. A transmission 71 is coupled to a flywheel provided in the flywheel housing 62 with interposition of, for example, a clutch (not shown). A propulsion unit of a ship, or the like, is coupled to the transmission 71. Thus, the output of the marine engine 1 can be transmitted to the propulsion unit or the like, and blocking of the transmission can be made.

An oil pan 63 is arranged on a surface (bottom surface) opposite to the top cover 10 with respect to the height direction. The oil pan 63 is a member for storage of an engine oil that is to be supplied to the inside of the engine (for example, to a component part included in a main drive system, such as the cylinder). The engine oil reserved in the oil pan 63 is sent out to the inside of the engine by means of an oil pump (not shown).

The engine oil sent out by the oil pump passes through an oil filter 26. As a result, metal powder, foreign substances, and the like, contained in the engine oil can be removed. In this embodiment, the oil filter 26 includes two filters (a full flow filter and a bypass filter).

The engine oil sent out by the oil pump passes through an oil filter 26. As a result, metal powder, foreign substances, and the like, contained in the engine oil can be removed. In this embodiment, the oil filter 26 includes two filters (a full flow filter and a bypass filter). The oil filter 26 is arranged near an end portion (an end portion on the side opposite to the side where the first turbocharger 22 is arranged) of the marine engine 1 with respect to the crank axis direction.

As shown in FIG. 4, an exhaust manifold 45 is arranged in an end portion on the second turbocharger 24 side with respect to the device width direction. In the exhaust manifold 45, exhaust gases discharged from a plurality of (in this embodiment, six) cylinders are collected and then sent out through one or more (in this embodiment, three) air discharge ports 46. The second turbocharger 24, an EGR pipe, and the like, are connected to the air discharge ports 46.

The exhaust gas sent out to the second turbocharger 24 is used to rotate the turbine of the second turbocharger 24, as mentioned above. The exhaust gas, after passing through the second turbocharger 24, is used to rotate the turbine of the first turbocharger 22, and then discharged.

The exhaust gas sent out to the EGR pipe is, through the air supply pipe 21d and the like, supplied to the cylinder again. This configuration achieves reduction of nitrogen oxides in the exhaust gas and improvement in the fuel efficiency.

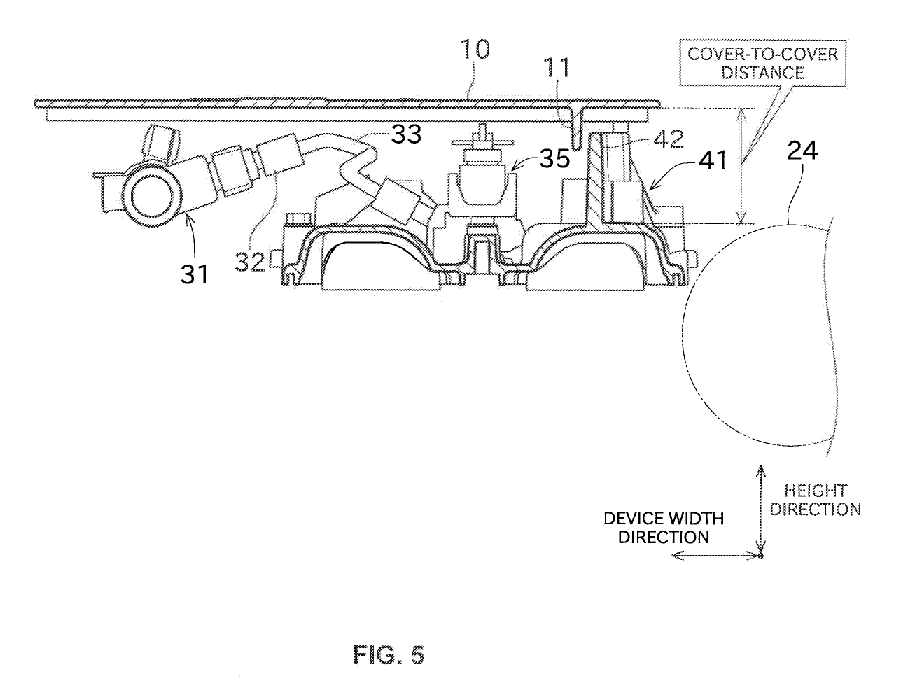

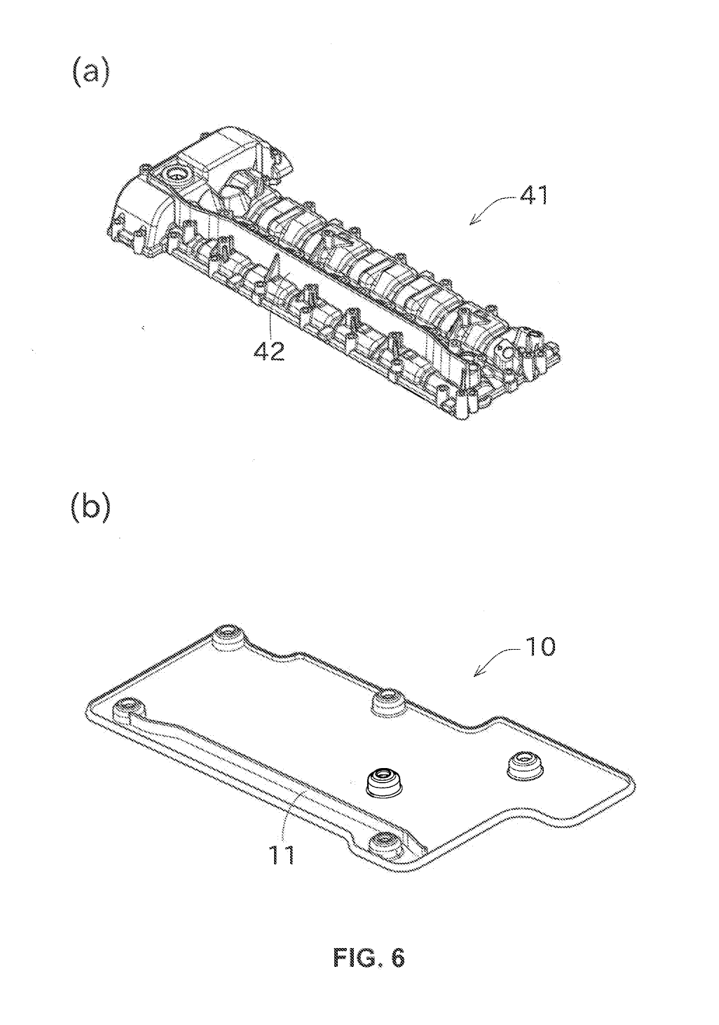

Next, details of the cylinder head and therearound, and particularly the fuel injection mechanism, the valve cover 41, and the top cover 10, will be described with reference to FIGS. 4 to 6. FIG. 5 is a cross-sectional view showing a space between the valve cover 41 and the top cover 10. FIG. 6 is perspective views showing the shapes of the valve cover 41 and the top cover 10.

As shown in FIGS. 4 and 5, the marine engine 1 includes a fuel injection mechanism implemented by a common rail 31, connectors 32, fuel supply pipes (fuel tubes) 33, a fuel return pipe (fuel tube) 34, and injectors 35. In FIG. 5, illustration of the fuel return pipe 34 is omitted for clarity of the drawing.

The common rail 31, which is a tube-shaped member made of a metal or other materials, is arranged above the valve cover 41 with its longitudinal direction parallel to the crank axis direction. A high-pressure fuel is supplied from a fuel tank to the common rail 31 by, for example, a high-pressure pump. The number of the connectors 32 included in the common rail 31 is equal to the number of cylinders (in this embodiment, six). The fuel supply pipes 33 are connected to the connectors 32, respectively.

The injectors 35 are arranged corresponding to the cylinders, respectively. The injectors 35 are connected to the common rail 31 via the fuel supply pipes 33 and the connectors 32. The injector 35, in response to an instruction from an electronic control device (not shown), injects the fuel. This configuration enables the fuel to be injected into each of the cylinders at an appropriate timing.

The fuel injection mechanism also includes a single fuel return pipe 34 that connects one end portion of the common rail 31 to the other end portion thereof. The fuel return pipe 34 is arranged so as to form a loop surrounding all the injectors 35. The injectors 35 returns a surplus of the supplied fuel through the fuel return pipe 34 to the common rail 31 or the fuel tank.

Next, the valve cover 41 will be described. The valve cover 41 is a cover arranged above the cylinders (above an air intake valve or an exhaust valve). The valve cover 41 has holes for mounting of the injectors 35, holes for fixing of the valve cover 41 to the cylinder block or the like. The valve cover 41 also has a second partition 42.

As shown in FIGS. 5 and 6(a), the second partition 42 is a plate-like part extending upward from the valve cover 41 toward the top cover 10 side (the upper side). The second partition 42 is formed across opposite end portions of the valve cover 41 with respect to the longitudinal direction (crank axis direction).

The second partition 42 is located on the second turbocharger 24 side (on the exhaust manifold 45 side) relative to the center with respect to the device width direction. More specifically, the second partition 42 is arranged so as to separate the side where the second turbocharger 24 is arranged (the side where the exhaust gas flows immediately after being discharged from the exhaust manifold 45) from the side where the fuel supply pipes 33 are arranged.

As shown in FIG. 5, the second partition 42 has a height that occupies half or more of the distance between the valve cover 41 and the top cover 10 (cover-to-cover distance). Here, the cover-to-cover distance means a distance obtained by vertical measurement of the distance to the top cover 10 from the position at Which the second partition 42 is formed (see FIG. 5). The second partition 42 is formed integrally with the valve cover 41 through, for example, a casting process it may not be indispensable that the second partition 42 is formed integrally with the valve cover 41, For example, the second partition 42 may be attached to the valve cover 41 by welding, screwing, or the like.

Next, the top cover 10 will be described, As mentioned above, the top cover 10 is a plate-like cover arranged so as to cover the valve cover 41. As shown in FIGS. 5 and 6(b), the top cover 10 is provided with a partition 11 that is a plate-like portion extending toward the valve cover 41 (the lower side).

The partition 11 is formed across opposite end portions of the top cover 10 with respect to the longitudinal direction (crank axis direction). The partition 11 is located on the second turbocharger 24 side (on the exhaust manifold 45 side) relative to the center with respect to the device width direction. More specifically, the partition 11 is arranged so as to separate the side where the second turbocharger 24 is arranged (the side where the exhaust gas flows immediately after being discharged from the exhaust manifold 45) from the side where the fuel supply pipes 33 are arranged. The partition 11 is formed integrally with the top cover 10 through, for example, a casting process. It may not be indispensable that the partition 11 is formed integrally with the top cover 10. For example, the partition 11 may be attached to the top cover 10 by welding, screwing, or the like.

The two partitions 11 and 42 are arranged so as to overlap each other when seen in the device width direction. The partition 11 is arranged near the second partition 42 and on the fuel supply pipe 33 side relative to the second partition 42.

Next, effects of the partitions 11 and 42 will be described with reference to FIG. 5.

In the fuel injection mechanism of this embodiment, the connectors 32 are configured so as to prevent leakage of the fuel between the common rail 31 and each fuel supply pipe 33. Depending on the use environment or the like, however, loosening of the connection, damage to the fuel supply pipes 33 or the fuel return pipe 34, or the like, may occur, which results in leakage of the fuel.

The exhaust gas, immediately after being discharged from the exhaust manifold 45, has a very high temperature. Accordingly, the surroundings of the air discharge ports 46, the second turbocharger 24 having the exhaust gas flowing therethrough, and the like, also have a very high temperature (hereinafter, called a high-temperature part). It is therefore necessary to prevent the high-temperature part from being exposed to the fuel in a case of occurrence of leakage and splashing of the fuel. In this embodiment, the partitions 11 and 42 mentioned above serve for preventing the high-temperature part from being exposed to the fuel.

For example, in a case where the fuel leaks out of the connector 32, the fuel bursts and splashes because of its high pressure. Even when part of the splashing fuel goes toward the second turbocharger 24, the partitions 11 and 42 are able to catch the fuel. Thus, the high-temperature part is prevented from being exposed to the fuel.

Here, a case is assumed where the second partition 42 is located closer to the fuel supply pipe 33 than the partition 11 is. In this case, when the fuel splashes along the top cover 10, the fuel may flow through a gap between the partition 11 and the second partition 42 and may reach the high temperature-side of the engine. In this respect, this embodiment has the partition 11 arranged closer to the fuel supply pipe 33 than the second partition 42 is, as described above. This enables the fuel, even splashing along the top cover 10, to be caught without fail.

As described above, the partitions 11 and 42 are arranged with one of them located near the other of them, so as to overlap each other when seen in the device width direction. This can more surely prevent the high-temperature part from being exposed to the splashing fuel.

As thus far described, the marine engine 1 includes the exhaust manifold 45, the valve cover 41, the top cover 10, and the fuel supply pipes 33 (or the fuel return pipe 34). The exhaust manifold 45 collects the exhaust gases discharged from the plurality of cylinders. The valve cover 41 is a cover that covers all of the air intake valve or the exhaust valve. The fuel supply pipe 33 is arranged outside the valve cover 41, and allows the fuel to flow therethrough. The top cover 10 is provided with the partition 11 that is arranged so as to separate the side where the exhaust gas flows immediately after being discharged from the exhaust manifold 45 from the side where the fuel supply pipe 33 is arranged.

Accordingly, even when the fuel leaks out of the fuel supply pipe 33, the part (the high-temperature part of the engine such as the second turbocharger 24) through which the exhaust gas passes can be prevented from being exposed to the fuel. This can eliminate the need of double-structuring the fuel supply pipe 33 for the purpose of preventing leakage of the fuel, and moreover can eliminate the need of covering an exhaust pipe and the like, with a heat insulating material for the purpose of lowering the surface temperature. Thus, reduction in the number of parts and simplification of an assembling operation are achieved.

In the marine engine 1 of this embodiment, the partition 11 has a height that occupies half or more of the cover-to-cover distance.

This makes it easy for the second partition 42 to catch the fuel splashing from the fuel supply pipe 33, thus more surely preventing the part through which the exhaust gas passes from being exposed to the fuel.

In the marine engine 1 of this embodiment, the partition 11 is formed so as to extend from one end to the other end of the top cover 10 with respect to the crank axis direction.

Accordingly, the second turbocharger 24 and the like can be prevented from being exposed to the fuel even in a case where the common rail 31 and the fuel supply pipes 33 are arranged in an elongated manner in the crank axis direction as illustrated in this embodiment.

In the marine engine 1 of this embodiment, the partition 11 is a plate-like portion that is formed integrally with the top cover 10 and that protrudes from the top cover 10.

Since the partition 11 and the top cover 10 are formed integrally with each other, reduction in the number of parts and simplification of the assembling operation are achieved. Additionally, since the partition 11 has a plate-like shape, the space occupied by the partition 11 can be restricted while the second turbocharger 24 and the like are prevented from being exposed to the fuel.

Next, arrangement of the oil filter 26 and the devices included in the two-stage turbocharging system of this embodiment will be described from various aspects in the following description, the devices (the first turbocharger 22, the first intercooler 23, the second turbocharger 24, and the second intercooler 25) included in the two-stage turbocharging system as well as the oil filter 26 may be collectively called “the turbochargers and the like”.

Firstly, referring to a plan view (FIG. 2), arrangement of the turbochargers and the like in a plan view will be described. Since the thickness direction of the top cover 10 is parallel to the height direction as mentioned above, a plan view in this embodiment can be also regarded as “a view as seen in the thickness direction of the top cover 10”.

The first turbocharger 22 is arranged in one end portion of the marine engine 1 with respect to the crank axis direction. All of the first intercooler 23, the second turbocharger 24, and the second intercooler 25 are arranged in one end portion of the marine engine 1 with respect to the device width direction. These three devices are arranged side by side with the first intercooler 23 located closer to the first turbocharger 22. The oil filter 26 is arranged in the other end portion (the end portion opposite to the transmission 71 side) of the marine engine 1 with respect to the crank axis direction.

In this embodiment, the turbochargers and the like are arranged so as not to overlap one another. This enables an operator who is working on the top cover 10 when performing a maintenance operation to perform the maintenance operation without the need to remove other devices, thus achieving a layout that facilitates the operation.

Next, referring to a front elevational view (FIG. 3), the positions of the turbochargers and the like with respect to the height direction will be described. In this embodiment, an upper surface of the top cover 10 constitutes a part of an upper surface of the marine engine 1. A lower surface of the oil pan 63 constitutes a part of a lower surface of the marine engine 1. Accordingly, the distance from the lower surface of the oil pan 63 to the upper surface of the top cover 10 can be considered as the height of the marine engine 1. In the following, half the height of the marine engine 1 will be defined as “reference height”, as shown in FIG. 3.

All of the turbochargers and the like are arranged higher (closer to the top cover 10) than the reference height. To be more specific, not only the upper ends of the turbochargers and the like but also middle portions and the lower ends thereof are located higher than the reference height. The first turbocharger 22, the first intercooler 23, and the second intercooler 25 are arranged with their upper surfaces being substantially identical to the upper surface of the marine engine 1.

Such a configuration in which the turbochargers and the like are arranged in an upper region of the marine engine 1 achieves a layout that allows an operator who is working on the top cover 10 in performing a maintenance operation to easily access the turbochargers and the like (the operation is facilitated).

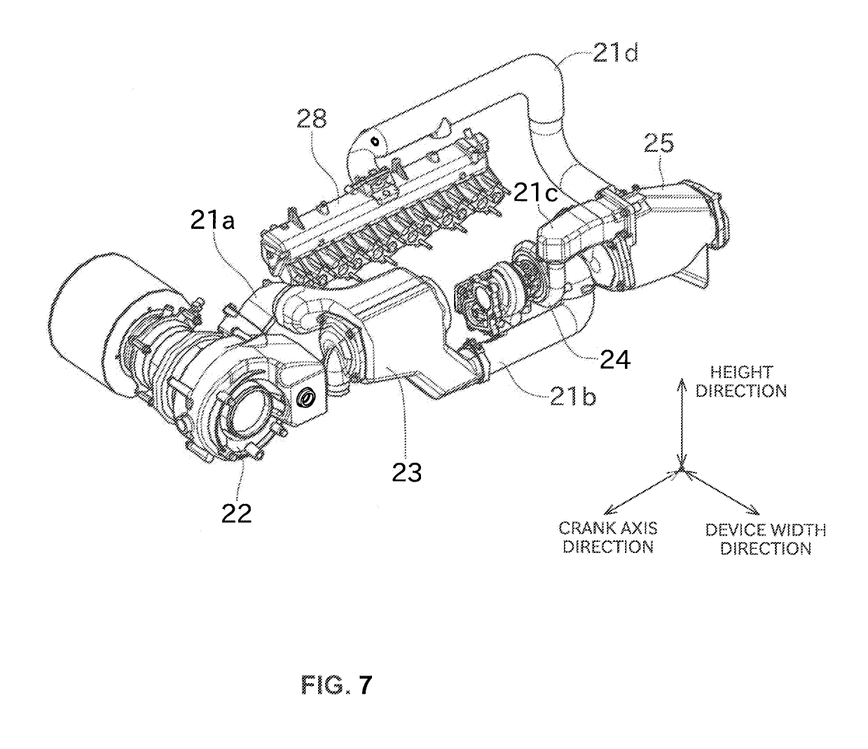

Next, comparison among the lengths of the air supply pipes 21a to 21d will be given with reference to a perspective view showing the positional relationship among the devices of the air supply system (FIG. 7).

Here, the length of the air supply pipe 21a means the length of a path of air extending from the first turbocharger 22 to the first intercooler 23. The same applies to the other air supply pipes. Therefore, this embodiment can provide comparison among the lengths of paths of air supplied to the cylinder based on comparison among the lengths of the air supply pipes.

In this embodiment, the condition that “the length of the air supply pipe 21a<the length of the air supply pipe 21b” is established, and the condition that “the length of the air supply pipe 21c<the length of the air supply pipe 21d” is established.

This configuration enables the air supply pipe 21a and the air supply pipe 21c, through which high-temperature air passes, to be relatively short. Accordingly, parts of all the air supply pipes that need to be covered with a heat insulating material or the like can be shortened, which leads to cost reduction.

Although a preferred embodiment of the present invention has been described above, the above-described configuration can be modified, for example, as follows.

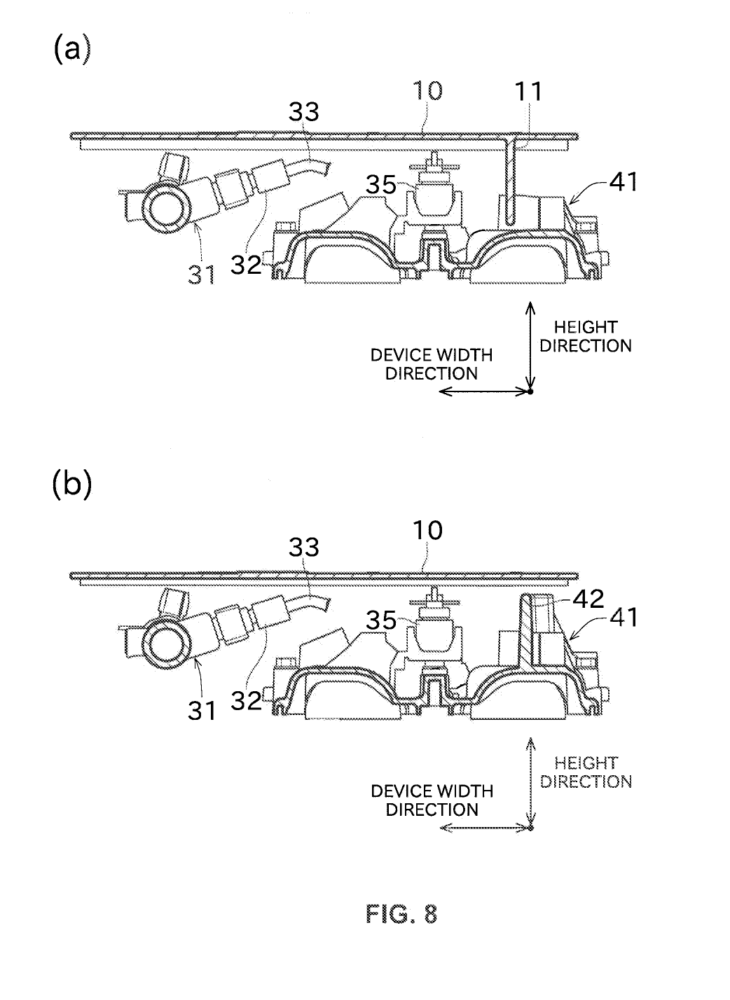

While the above-described embodiment adopts combined use of the partition 11 and the second partition 42, the effects of the present invention can be exerted also by a configuration including the partition 11 alone (see FIG. 8(a)) or a configuration including the second partition 42 alone (see FIG. 8(b)). Since the above-described embodiment adopts combined use of two partitions, the partition 11 has a short length. In a case where the second partition 42 is not provided, however, it is preferable that the partition 11 has a large length. In FIG. 8(a), the length of the partition 11 is half or more of the cover-to-cover distance.

The shapes of the parts included in the marine engine 1 and the layout thereof are merely illustrative, and can be modified as appropriate. For example, the number of cylinders, the arrangement of the turbochargers and the intercoolers, and the like, may be changed in accordance with, for example, a required size or specifications.

The fuel injection mechanism need not always be of electronic control type, but may be of mechanical type that drives arranged injection pumps by means of a cam, for example. Moreover, the fuel injection mechanism need not always be of common rail type.

In the configuration illustrated above, the partitions 11 and 42 have plate-like shapes, but any appropriate shape is adoptable as long as it is able to catch a splashing fuel. The positions where the partitions 11 and 42 are provided can be changed as long as the partitions 11 and 42 are arranged so as to separate the high-temperature part of the engine from the fuel supply pipe 33 and the fuel return pipe 34.

The present invention is applicable to either main equipment or auxiliary equipment for use in a ship. Furthermore, the present invention is applicable not only to ships but also to engines of automobiles or work vehicles.

### DESCRIPTION OF THE REFERENCE NUMERALS

1 marine engine (engine)
10 top cover (plate-like cover)
11 partition
21a to 21d air supply pipe
22 first turbocharger
23 first intercooler
24 second turbocharger
25 second intercooler
31 common rail
32 connector
33 fuel supply pipe (fuel tube)
34 fuel return pipe (fuel tube)
35 injector
41 valve cover
42 second partition

What is claimed is:

1. An engine comprising:
an exhaust manifold that collects exhaust gases discharged from a plurality of cylinders;
a valve cover that covers all of a plurality of valves for air intake or air discharge to or from the cylinders;
a plate-like cover that covers the valve cover; and
a fuel tube arranged in a space between the valve cover and the plate-like cover, the fuel tube allowing a fuel to flow therethrough,
the plate-like cover being provided with a partition that is arranged so as to separate a side where the exhaust gas flows immediately after being discharged from the exhaust manifold from a side where the fuel tube is arranged.

2. The engine according to claim 1, wherein
the partition has a height that occupies half or more of the distance between the valve cover and the plate-like cover.

3. The engine according to claim 1, wherein
the partition is formed so as to extend from one end to the other end of the plate-like cover with respect to a crank axis direction.

4. The engine according to claim 1, wherein
the partition is a plate-like portion that is formed integrally with the plate-like cover and that protrudes perpendicularly from the plate-like cover.

5. The engine according to claim 1, wherein
the valve cover being provided with a second partition that is arranged so as to separate the side where the exhaust gas flows immediately after being discharged from the exhaust manifold from the side where the fuel tube is arranged.

6. The engine according to claim 5, wherein
the second partition has a height that occupies half or more of the distance between the valve cover and the plate-like cover.

7. The engine according to claim 5, wherein
the second partition is formed so as to extend from one end to the other end of the valve cover with respect to a crank axis direction.

8. The engine according to claim 5, wherein
the second partition is a plate-like portion that is formed integrally with the valve cover and that protrudes from the valve cover.

9. The engine according to claim 5, wherein
the partition is arranged near the second partition and on the fuel tube side relative to the second partition.
